(19) United States
(12) Patent Application Publication
(10) Pub. No.: US 2025/0042020 A1
(43) Pub. Date: Feb. 6, 2025

(54) HUMANOID ROBOT

(71) Applicant: APPTRONIK, INC., Austin, TX (US)

(72) Inventors: Paul Gloninger FLEURY, Austin, TX (US); Nicholas Arden PAINE, Austin, TX (US); Jonas Alexan FOX, Austin, TX (US)

(21) Appl. No.: 18/717,073

(22) PCT Filed: Dec. 6, 2022
(86) PCT No.: PCT/US2022/052031

§ 371 Date: Jun. 6, 2024

Related U.S. Application Data
(60) Provisional application No. 63/286,426, filed on Dec. 6, 2021.

(51) Int. Cl. B25J 9/10; B25J 18/00

(52) U.S. Cl. CPC B25J 9/104; B25J 18/00

(57) ABSTRACT

A humanoid robot includes a base, a robotic torso coupled to the base, at least one robotic arm, at least one robotic shoulder coupling the at least one robotic arm to the robotic torso, a robotic neck coupled to the robotic torso, and a plurality of actuators configured to move at least a portion of at least one of the robotic torso, the at least one robotic arm, the at least one robotic shoulder, and the robotic neck. Each of the robotic torso, the at least one robotic arm, the at least one robotic shoulder, and the robotic neck is defined by one or more proportions that deviates less than 25% from respective proportions of a human envelope.

### TECHNICAL FIELD

The present disclosure describes robotic systems, such as upper-body humanoid robots.

### BACKGROUND

Part of what makes many robots appear strange or unfamiliar is that they lack human proportions. As a result, many robots do not exhibit natural movements that closely mimic the movement of a human being, and, as a result cannot successfully perform various tasks when interacting with human made environments.

### SUMMARY

Embodiments described herein provide an upper-body humanoid robot for use in human made environments. More particularly, embodiments can fit within a desired percentage of a human envelope. For example, some embodiments fit within a human envelope with less than 25% deviation, and even more preferably, with less than 20% deviation in torso length, shoulder width, bicep length and forearm length.

The human envelope can be defined by a set of proportions, such as described in Biomechanics and Motor Control of Human Movement, David A. Winter, Wiley; 4th edition (Oct. 12, 2009), which is hereby fully incorporated by reference herein in its entirety. Appendix A illustrates the average human proportions. Further a table is provided that includes a set of upper body lengths for an average human according to the proportions, using an example height of 1494 mm. The table also illustrates an example set of upper body lengths for a robotic torso in which each length has less than 20% deviation from the relevant upper body length based on the average human proportions.

Embodiments can also exhibit natural, anthropomorphic motion and dexterous environmental interactions. Further, embodiments described herein can include a compact mechanical layout, a wire routing scheme that reduces external wiring and stress on wiring, and/or compact embedded electronics distributed in a manner to enhance cable management.

In an example implementation, a humanoid robot includes a base, a robotic torso coupled to the base, at least one robotic arm, at least one robotic shoulder coupling the at least one robotic arm to the robotic torso, a robotic neck coupled to the robotic torso, and a plurality of actuators configured to move at least a portion of at least one of the robotic torso, the at least one robotic arm, the at least one robotic shoulder, and the robotic neck. Each of the robotic torso, the at least one robotic arm, the at least one robotic shoulder, and the robotic neck is defined by one or more proportions that deviates less than 25% from respective proportions of a human envelope.

In an aspect combinable with the example implementation, a height of the robotic torso ranges between 75% of a height of an average human torso and 125% of the height of the average human torso.

In another aspect combinable with any of the previous aspects, a width of the robotic shoulder ranges between 75% of a width of an average human shoulder and 125% of the width of the average human shoulder.

In another aspect combinable with any of the previous aspects, the at least one robotic arm includes a robotic bicep, a robotic forearm, a robotic elbow coupling the robotic bicep and the robotic forearm, and a robotic wrist.

In another aspect combinable with any of the previous aspects, a length of the robotic bicep ranges between 75% of a length of an average human bicep and 125% of the length of the average human bicep.

In another aspect combinable with any of the previous aspects, a length of the robotic forearm ranges between 75% of a length of an average human forearm and 125% of the length of the average human forearm.

In another aspect combinable with any of the previous aspects, the plurality of actuators includes a shoulder abduction-adduction (AA) actuator coupled to the robotic shoulder and the robotic bicep, the shoulder AA actuator configured to control abduction and adduction of the robotic arm.

Another aspect combinable with any of the previous aspects further includes a shoulder FE output structure configured to couple the shoulder AA actuator with a shoulder FE actuator configured to control flexion and extension of the robotic arm, the shoulder FE output structure configured to act as a mechanical ground for the shoulder AA actuator and is configured to cause abduction and adduction of the robotic arm.

In another aspect combinable with any of the previous aspects, the shoulder FE output structure includes a first arm coupled to a first side of the shoulder AA actuator, and a second arm coupled to a second side of the shoulder AA actuator.

Another aspect combinable with any of the previous aspects further includes a shoulder AA output structure, the shoulder AA output structure including a first arm coupled to the shoulder AA actuator, and a second arm coupled to the shoulder FE output structure.

In another aspect combinable with any of the previous aspects, the shoulder AA output structure is coupled to the shoulder FE output structure by a bearing.

Another aspect combinable with any of the previous aspects further includes a shoulder AA actuator driver configured to move the shoulder AA actuator, and cabling configured to electronically couple the shoulder AA actuator driver to an electronic controller, the cabling extending between the shoulder AA actuator driver and an shoulder FE actuator driver.

In another aspect combinable with any of the previous aspects, the plurality of actuators includes an arm internal/external (IE) rotation actuator coupled to the robotic bicep, the arm IE rotation actuator configured to control internal rotation and external rotation of the robotic arm.

Another aspect combinable with any of the previous aspects further includes an arm IE rotation actuator driver configured to move the arm IE rotation actuator, and cabling configured to electronically couple the arm IE rotation actuator driver to an electronic controller, the cabling extending between the arm IE rotation actuator driver and an shoulder AA actuator driver.

In another aspect combinable with any of the previous aspects, the cabling is routed to bend through an axis of rotation of a shoulder AA actuator corresponding to the shoulder AA actuator driver.

In another aspect combinable with any of the previous aspects, the plurality of actuators includes an arm flexion-extension (FE) actuator coupled to the robotic elbow, the arm FE actuator configured to control flexion and extension of the robotic forearm relative to the robotic bicep.

Another aspect combinable with any of the previous aspects further includes an IE rotation output structure configured to couple the arm FE actuator with an arm IE rotation actuator configured to internal rotation and external rotation of the robotic arm, the IE rotation output structure configured to act as a mechanical ground for the arm FE actuator and is configured to cause rotation of a lower portion of the robotic bicep relative to an upper portion of the robotic bicep.

In another aspect combinable with any of the previous aspects, the IE rotation output structure includes a first arm coupled to a first side of the arm FE actuator, and a second arm coupled to a second side of the arm FE actuator.

Another aspect combinable with any of the previous aspects further includes an arm FE actuator driver configured to move the arm FE actuator, and cabling configured to electronically couple the arm FE actuator driver to an electronic controller, the cabling extending between the arm FE actuator driver and an arm IE rotation actuator driver.

In another aspect combinable with any of the previous aspects, the cabling is routed to wrap around a structure coaxially with an axis of rotation of an arm IE rotation actuator corresponding to the arm IE rotation actuator driver.

In another aspect combinable with any of the previous aspects, the plurality of actuators includes a wrist yaw actuator coupled to the robotic wrist and configured to rotate a tool connected to the robotic arm.

Another aspect combinable with any of the previous aspects further includes an elbow output structure configured to couple the wrist yaw actuator with an arm FE actuator configured to control flexion and extension of the robotic forearm relative to the robotic bicep, the elbow output structure configured to act as a mechanical ground for the wrist yaw actuator and is configured to cause flexion and extension of the robotic forearm relative to the robotic bicep.

In another aspect combinable with any of the previous aspects, the elbow output structure includes a first arm coupled to the arm FE actuator, and a second arm coupled to an IE rotation output structure.

In another aspect combinable with any of the previous aspects, the second arm is coupled to the IE rotation output structure by a bearing.

Another aspect combinable with any of the previous aspects further includes a wrist yaw actuator driver configured to move the wrist yaw actuator, and cabling configured to electronically couple the wrist yaw actuator driver to an electronic controller, the cabling extending between the wrist yaw actuator driver and an arm FE actuator driver.

In another aspect combinable with any of the previous aspects, the cabling is routed to bend through an axis of rotation of an arm FE actuator corresponding to the arm FE actuator driver.

In another aspect combinable with any of the previous aspects, wherein the plurality of actuators includes a torso yaw actuator coupled to the robotic torso and the base and configured to rotate the robotic torso relative to the base.

Another aspect combinable with any of the previous aspects further includes a torso yaw actuator driver configured to move the torso yaw actuator, and cabling configured to electronically couple the torso yaw actuator driver to an electronic controller, the cabling extending between the torso yaw actuator driver and torso pitch actuator driver.

In another aspect combinable with any of the previous aspects, the cabling is routed in an S-shaped path between the torso yaw actuator driver and the torso pitch actuator driver.

In another aspect combinable with any of the previous aspects, the robotic torso includes an upper torso and a lower torso; and the plurality of actuators includes a torso pitch actuator coupled to the upper torso and the lower torso, the torso pitch actuator configured to control angular movement of the upper torso forwards and backwards relative to the lower torso.

Another aspect combinable with any of the previous aspects further includes a torso rolling joint. The torso rolling joint includes an upper joint, a lower joint, a radial constraint configured to maintain a distance between the upper joint and the lower joint, and a transmission belt driven by the torso pitch actuator to cause the upper joint to translate relative to the lower joint.

In another aspect combinable with any of the previous aspects, the torso rolling joint further includes at least one rotational constraint cable coupled to the upper joint and the lower joint and configured to constrain rotational movement of the upper joint and the lower joint.

In another aspect combinable with any of the previous aspects, the plurality of actuators includes a shoulder flexion-extension (FE) actuator coupled to the robotic torso and the robotic shoulder, the shoulder FE actuator configured to control flexion and extension of the robotic arm.

In another aspect combinable with any of the previous aspects, the plurality of actuators includes a neck yaw actuator coupled to the robotic torso and the robotic neck, the neck yaw actuator configured to rotate the robotic neck relative to the robotic torso.

In another aspect combinable with any of the previous aspects, the robotic neck includes an upper neck portion and a lower neck portion, and the plurality of actuators includes a neck roll actuator coupled to the lower neck portion and configured to control movement of the upper neck portion relative to the lower neck portion.

Another aspect combinable with any of the previous aspects further includes a neck roll actuator driver configured to move the neck roll actuator, and cabling configured to electronically couple the neck roll actuator driver to an electronic controller, the cabling extending between the neck roll actuator driver and a neck yaw actuator driver.

In another aspect combinable with any of the previous aspects, the cabling is routed and configured to bend through an axis of rotation of a neck yaw actuator corresponding to the neck yaw actuator driver.

In another aspect combinable with any of the previous aspects, the plurality of actuators includes a neck pitch actuator coupled to the robotic neck and configured to control angular movement of a head coupled to the robotic neck.

Another aspect combinable with any of the previous aspects further includes a neck pitch actuator driver configured to move the neck pitch actuator, and cabling configured to electronically couple the neck pitch actuator driver to an electronic controller, the cabling extending between the neck pitch actuator driver and a neck roll actuator driver.

In another aspect combinable with any of the previous aspects, the cabling is routed and configured to bend through an axis of rotation of a neck roll actuator corresponding to the neck roll actuator driver.

Another aspect combinable with any of the previous aspects further includes a plurality of actuator drivers corresponding to the plurality of actuators and configured to move the respective a plurality of actuators, and an electronic controller communicably coupled to each of the plurality of actuator drivers.

In another aspect combinable with any of the previous aspects, each of the plurality of actuator drivers are positioned relative to the respective actuator of the plurality of actuators to prevent movement of the respective actuator driver relative to the respective actuator.

Another aspect combinable with any of the previous aspects further includes cabling communicably coupling each of the plurality of actuator drivers to the electronic controller.

In another aspect combinable with any of the previous aspects, a ratio between a length of a cable path between two of the plurality of actuator drivers to a total length of the cabling is less than or equal to 0.125.

In another aspect combinable with any of the previous aspects, the cabling is configured to maintain a bend radius greater than or equal to 20 millimeters.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of a system architecture for an example embodiment of an upper-body humanoid robot;

FIG. 2 illustrates a front oblique view of an example embodiment of an upper-body humanoid robot;

FIG. 3 is a block diagram of an example embodiment of an upper-body humanoid robot and a cross-sectional view of an example embodiment of an upper body-humanoid robot;

FIG. 4A illustrates a cross-sectional view of a portion of an example embodiment of an upper-body humanoid robot;

FIG. 4B illustrates a top cross-sectional view of a portion of an example embodiment of an upper-body humanoid robot;

FIG. 4C is the cross-sectional view of FIG. 4B with illustrative blocks added to emphasize certain features;

FIG. 5A illustrates a cross-sectional view of an example embodiment of an upper-body humanoid robot;

FIG. 5B illustrates a cross-sectional view of a portion of an arm of an example embodiment of an upper-body humanoid robot;

FIG. 5C is the cross-sectional view of FIG. 5B with illustrative blocks added to emphasize certain features;

FIG. 6A is a cross-sectional view of an example embodiment of a robotic arm;

FIG. 6B is the cross-sectional view of FIG. 6A with illustrative blocks added to emphasize certain features;

FIGS. 7A-7C illustrate the change in wiring path length as a joint rotates;

FIGS. 8A-8C illustrate an example embodiment of routing wiring from a shoulder FE actuator driver to a shoulder AA actuator driver;

FIG. 9A and FIG. 9B illustrate an example embodiment of routing wiring from a shoulder AA actuator driver to an arm IE rotation actuator driver;

FIG. 10 illustrates an example embodiment of routing wiring from an arm IE rotation actuator driver to an arm FE actuator driver;

FIG. 11 illustrates an example embodiment or routing wiring from an arm FE actuator driver to a wrist yaw actuator driver;

FIG. 12 illustrates an example embodiment of routing wiring to a neck yaw actuator driver and a neck roll actuator driver;

FIG. 13 illustrates an example embodiment of routing wiring from a neck roll actuator driver to a neck pitch actuator driver;

FIGS. 14A and 14B illustrate an example embodiment of routing wiring to a torso pitch actuator driver;

FIG. 15 illustrates an example embodiment of distributed electronics; and

FIG. 16A-16E illustrate an example embodiment of a torso rolling joint.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

As mentioned above, it can be desirable for a robot to have generally human proportions. Embodiments described herein can provide an upper-body humanoid robot that can fit with a desired percentage of a human envelope. For example, measurements such as torso height, shoulder width, bicep length, and forearm length can have 25% or less deviation from a human of average proportions.

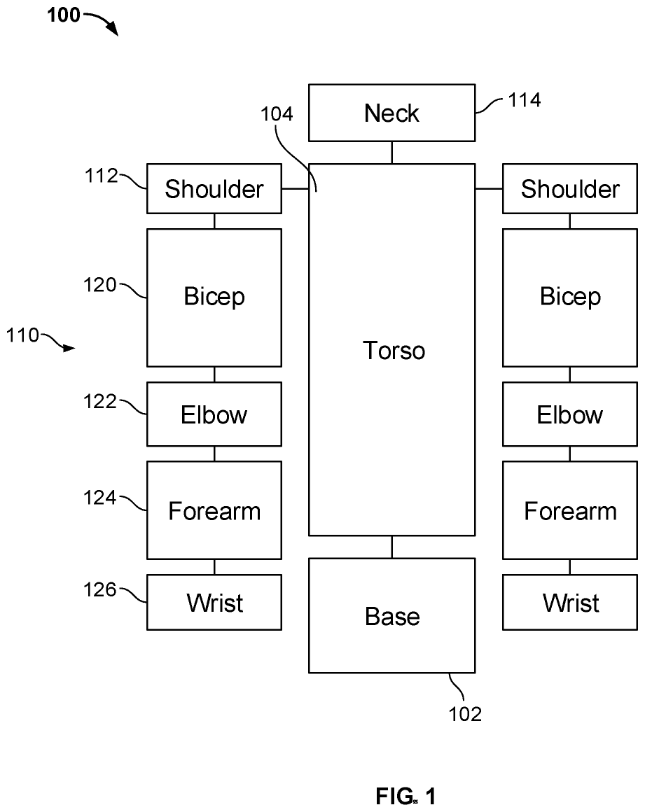

FIG. 1 is a block diagram of a general system architecture for an example embodiment of an upper-body humanoid robot 100. In the illustrated embodiment, upper-body humanoid robot 100 includes a base 102, a torso 104, arms (e.g., arm 110) coupled to the torso by shoulders (e.g., shoulder 112), and a neck 114. Each arm includes a bicep 120, an elbow 122, a forearm 124, and a wrist 126.

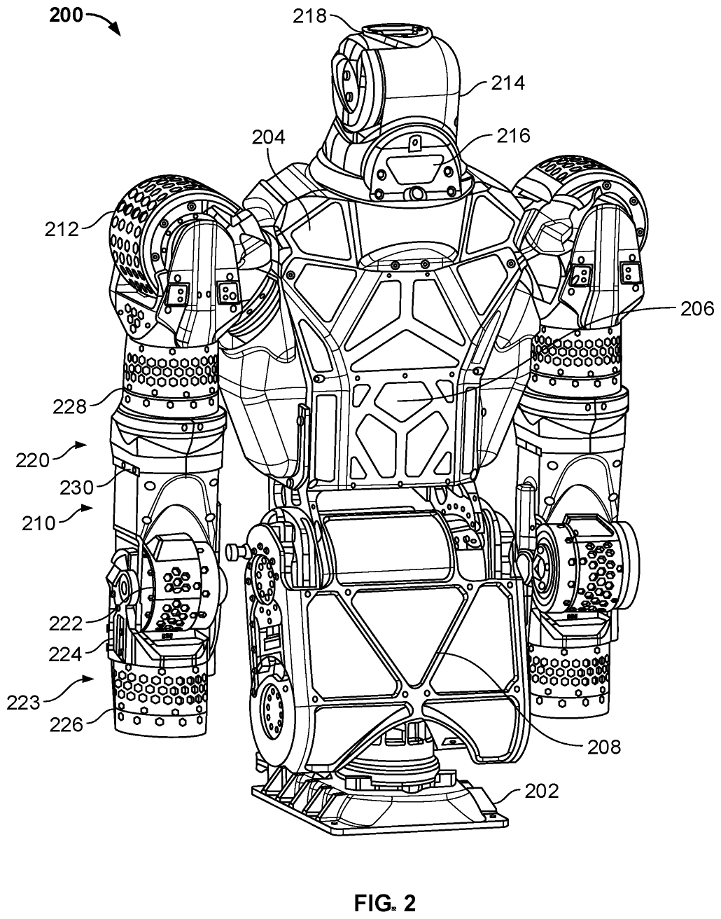

FIG. 2 illustrates a front oblique view of an example embodiment of an upper-body humanoid robot 200 according to the system architecture of FIG. 1. In the illustrated embodiment, upper-body humanoid robot 200 includes a base 202, a torso 204, arms (e.g., arm 210) coupled to the torso by shoulders (e.g., shoulder 212), and a neck 214. Base 202 can act as a mechanical ground for upper-body humanoid robot 200. Base can be mounted to, for example, a stationary or mobile surface. In other embodiments, the base can be provided by a pelvis section or other section coupled to legs to form a complete humanoid robot. Torso 204 includes an upper torso 206 coupled to a lower torso 208 by a joint. Neck 214 includes lower neck 216 and upper neck 218. Each arm includes a bicep 220, an elbow 222, and a lower arm 223. Lower arm 223 includes a forearm 224 and a wrist 226. Bicep 220 includes upper bicep 228 and lower bicep 230. A head (not shown) can be coupled to neck 214, and hands or other manipulators can be coupled to the wrists.

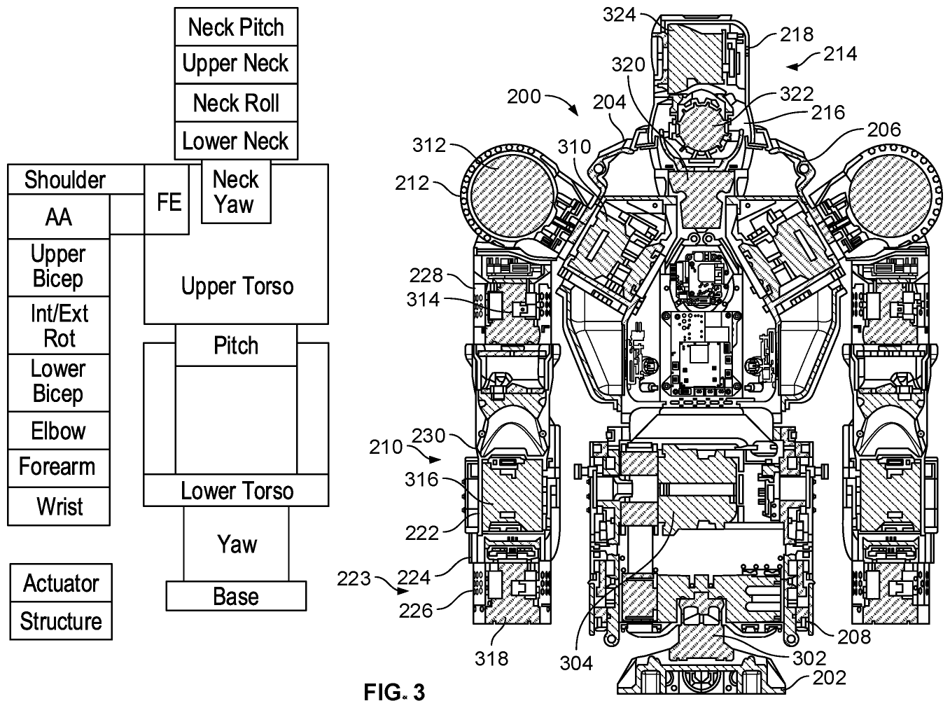

Upper-body humanoid robot 200 can support a variety of actuator-driven motions. FIG. 3 provides a block diagram of an example embodiment of an upper-body humanoid robot and a cross-sectional view of an example embodiment of an upper body-humanoid robot illustrating various actuators. In the embodiment illustrated, upper-body humanoid robot 200 includes a torso yaw actuator 302 coupled lower torso 208 and base 202 to rotate torso 204 relative to base 202 and a torso pitch actuator 304 coupled to lower torso 208 and upper torso 206 to lean upper torso 206 forward and back relative to lower torso 208. Upper torso 206 includes a shoulder flexion-extension (FE) actuator 310 coupled to shoulder 212 to drive flexion and extension of arm 210 (lifting the arm to the front and rear). Shoulder 212 includes a shoulder abduction-adduction (AA) actuator 312 coupled to upper bicep 228 to drive abduction and adduction of arm 210. Upper bicep 228 includes internal/external (IE) rotation actuator 314 to drive IE rotation of the arm. Elbow 222 includes an arm FE actuator 316 to drive flexion-extension of the forearm 224 relative to bicep 220. Wrist 226 includes a wrist yaw actuator 318 to rotate a manipulator or other tool connected to the arm. Upper torso 206 includes a neck yaw actuator 320 to rotate neck 214. Lower neck 216 includes neck roll actuator 322 to roll upper neck 218 relative to lower neck 216. Upper neck 218 includes neck pitch actuator 324 to tilt the head (not shown).

As mentioned, upper-body humanoid robot 200 can be dimensioned to fit with a desired deviation of a human envelope, which results in limited space for components, such as actuators. Embodiments described herein kinematically link sections of the upper-body humanoid robot 200 together in a manner that reduces the required volume.

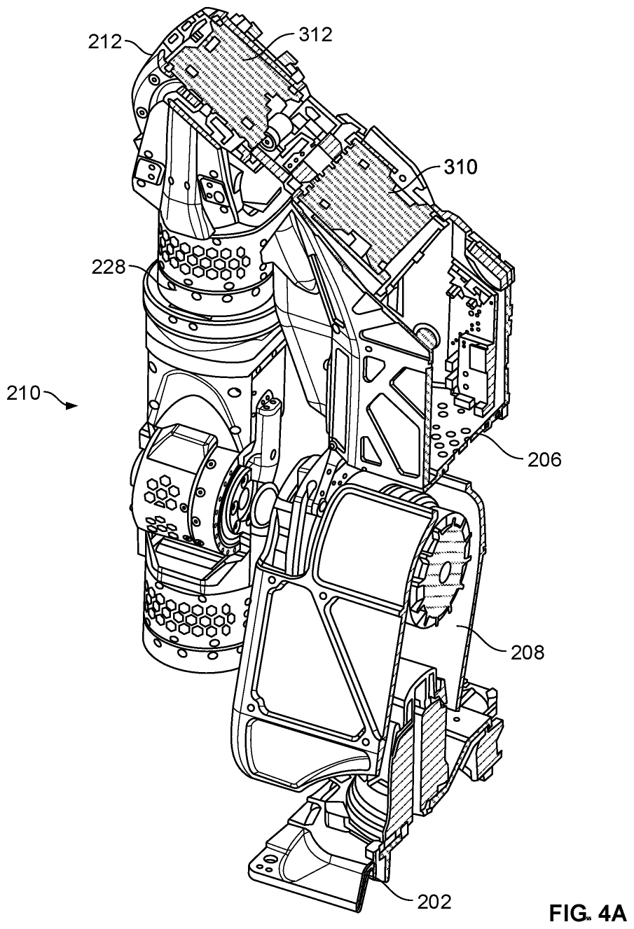

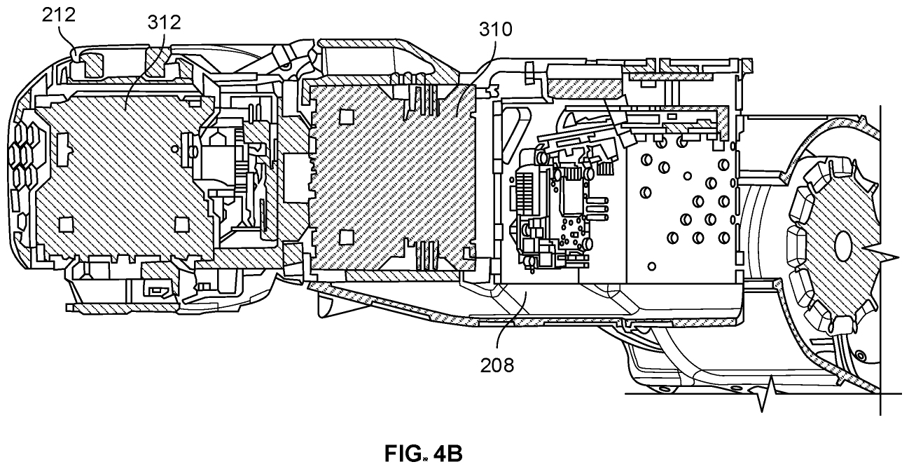

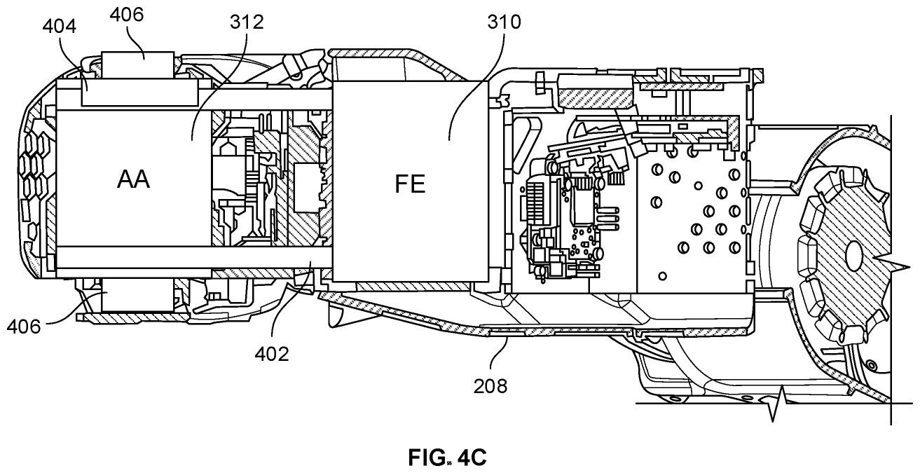

FIG. 4A illustrates a cross-sectional view of a portion of an example embodiment of an upper-body humanoid robot, FIG. 4B illustrates a top cross-sectional view of a portion of an example embodiment of an upper-body humanoid robot, and FIG. 4C is the view of FIG. 4B with illustrative blocks added to emphasize certain features. Shoulder FE output structure 402 provides an output path from shoulder FE actuator 310 to shoulder AA actuator 312 and acts as a mechanical ground for shoulder AA actuator 312. As illustrated, shoulder FE output structure 402 has a clevis arrangement with a first arm that connects to the output side, but not the output of, shoulder AA actuator 312 and another arm that connects to the other side of shoulder AA actuator 312. As shoulder FE actuator 310 rotates, the arm will raise and lower to the front and rear of the torso, with shoulder AA actuator 312 rotating with shoulder FE output structure 402. The clevis-like arrangement of shoulder FE output structure 402 in which the arms of the shoulder FE output structure 402 are spaced near the ends of the usable envelope with the actuator in the middle provides a stiffer and lighter weight structure for a given volume than connecting the shoulder FE output structure 402 to shoulder AA actuator 312 on one side. This helps the upper-body humanoid robot 200 remain within the human envelope while achieving desired performance characteristics.

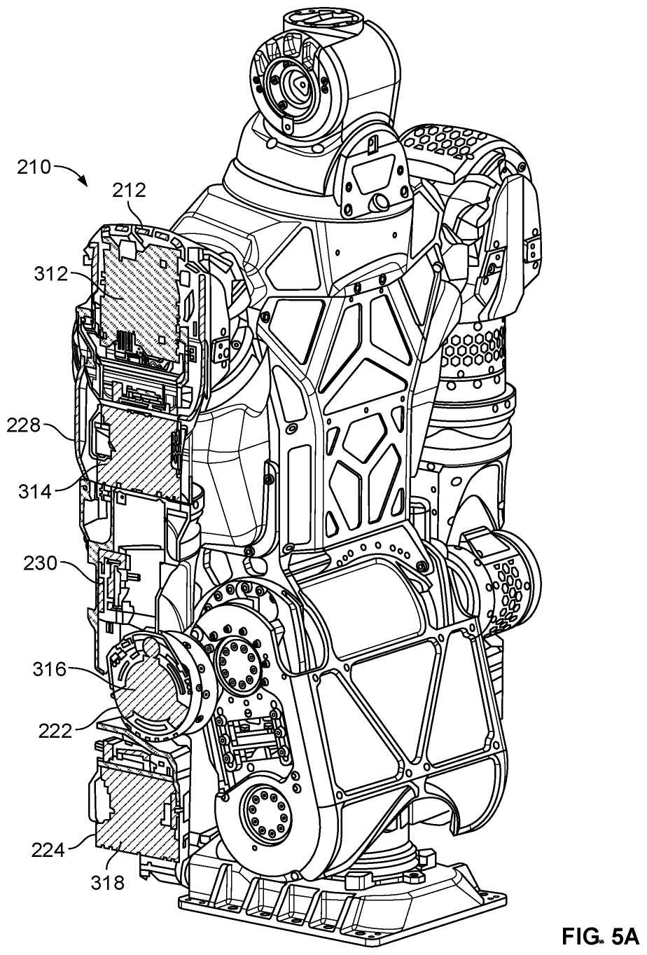

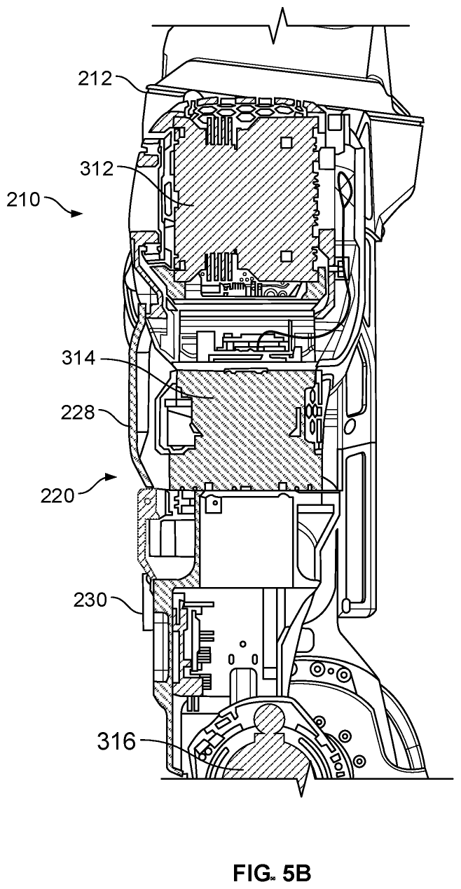

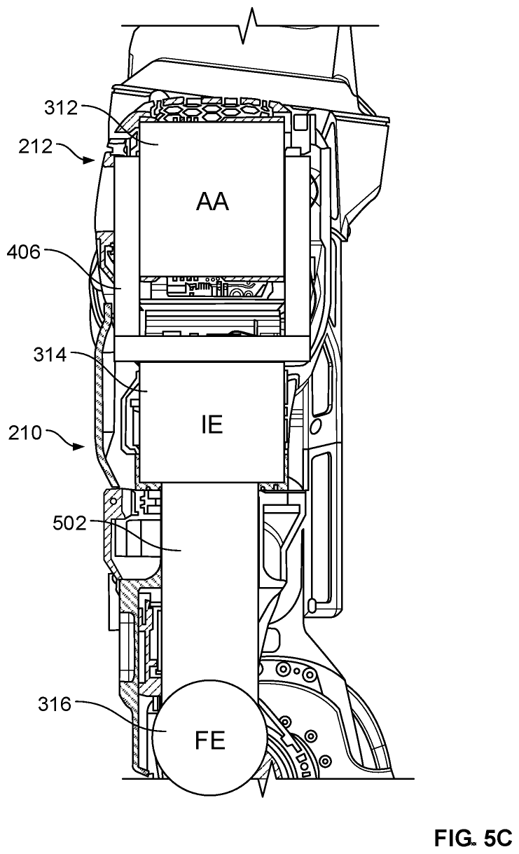

A shoulder AA output structure 406 is connected to the output of shoulder AA actuator 312 on one side. On the other side of shoulder AA actuator 312, shoulder AA output structure 406 is coupled to shoulder FE output structure 402 by a bearing 404. An example embodiment of shoulder AA output structure 406 is further described below. FIG. 5A illustrates a cross-sectional view of an example embodiment of an upper-body humanoid robot, FIG. 5B illustrates a cross-sectional view of a portion of an arm of an example embodiment of an upper-body humanoid robot, and FIG. 5C is the view of FIG. 5B with illustrative blocks added to emphasize certain features.

As can be seen in FIG. 5C, shoulder AA output structure 406 provides an output path from shoulder AA actuator 312 to arm IE rotation actuator 314 and acts as a mechanical ground for arm IE rotation actuator 314. As illustrated, shoulder AA output structure 406 has a clevis arrangement with a first arm that connects to the output of shoulder AA actuator 312 and another arm that couples to shoulder FE output structure 402 by bearing 404. Shoulder AA actuator 312 can drive shoulder AA output structure 406 to abduct-adduct arm 210. Again, the clevis-like arrangement of shoulder AA output structure 406 in which the structure's arms spaced near the ends of the usable envelope with the actuator in the middle provides a stiffer and lighter weight structure for the given volume than connecting to shoulder AA actuator 312 on one side. Again, this helps the upper-body humanoid robot 200 to remain within the human envelope while achieving desired performance characteristics.

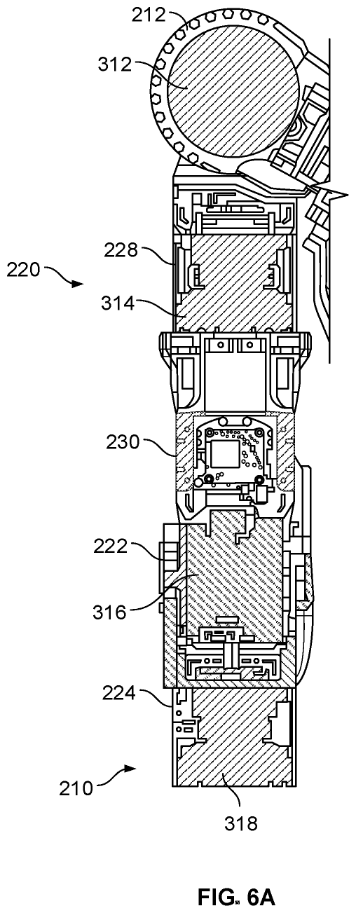

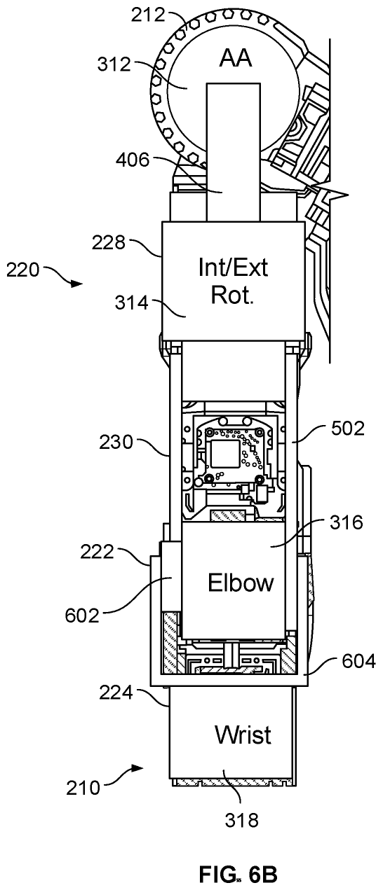

Also illustrated is IE rotation output structure 502. An example embodiment of IE rotation output structure 502 is further illustrated in FIG. 6A and FIG. 6B. FIG. 6A is a cross-sectional view of an example embodiment of a robotic arm, and FIG. 6B is the view of FIG. 6A with illustrative blocks added to emphasize certain features. As depicted in FIG. 6B, IE rotation output structure 502 provides an output path from arm IE rotation actuator 314 to arm FE actuator 316 and acts as a mechanical ground for arm FE actuator 316. As illustrated, IE rotation output structure 502 has a clevis arrangement with a first arm that connects to the output side, but not the output of, arm FE actuator 316 and another arm that connects to the other side of arm FE actuator 316. Arm IE rotation actuator 314 can drive IE rotation output structure 502 to rotate lower bicep 230 relative to upper bicep 228. Again, the clevis-like arrangement of IE rotation output structure 502 in which the structure's arms are spaced near the ends of the usable envelope with the actuator in the middle provides a stiffer and lighter weight structure for the given volume than connecting the IE rotation output structure 502 to arm FE actuator 316 on one side of the arm FE actuator 316. This helps the upper-body humanoid robot 200 to remain within the human envelope while achieving desired performance characteristics.

An elbow output structure 604 provides an output path from arm FE actuator 316 to wrist yaw actuator 318 and acts as a mechanical ground for wrist yaw actuator 318. Elbow output structure 604 is connected to the output of arm FE actuator 316 on one side. On the other side of arm FE actuator 316, elbow output structure 604 is coupled to IE rotation output structure 502 by a bearing 602. The other end of elbow output structure 604 provides a mechanical ground for wrist yaw actuator 318.

As illustrated, elbow output structure 604 has a clevis arrangement with a first arm that connects to the output of arm FE actuator 316 and another arm that couples to IE rotation output structure 502 by bearing 602. Arm IE rotation actuator 314 can drive elbow output structure 604 to flex/extend forearm 224 relative to lower bicep 230. Again, the clevis-like arrangement of elbow output structure 604 in which the structure's arms spaced near the ends of the usable envelope with the arm FE actuator 316 in the middle provides a stiffer and lighter weight structure for a given volume than connecting elbow output structure 604 to arm FE actuator 316 on one side of arm FE actuator 316. This helps the upper-body humanoid robot 200 to remain within the human envelope while achieving desired performance characteristics.

Another issue that makes some robots appear less human and not conform to a human envelope is excessive cabling that is visible outside of the robot's outer shell. This excessive wiring can also present a snag hazard. Some embodiments minimize external cabling by maintaining cabling internally or minimizing external cabling. Embodiments described herein also help maintain cabling within the human envelope without putting undue stress on the cabling. More particularly, embodiments can define wire paths across joints to minimize stress on both sides of the joint, which allows for no or minimum strain on the board connectors to which cabling connects.

Cabling and board joints can experience undue stress when the ratio of cable path length change to total cable length is too high. Minimizing the cable path length change through the range of motion of a joint to total cable length (referred to as cable length change/total cable length in Appendix A) can ensure that cable does not stretch and put unnecessary stress on the cable, connectors, or boards. Furthermore, bending cables with too sharp a radius can induce local stresses in the cable, which can propagate to apply stresses on the connectors or boards. Embodiments described herein can implement features to minimize cable path length change and maximize bend radius.

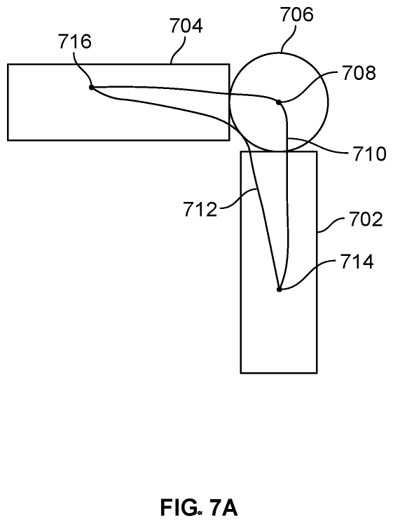

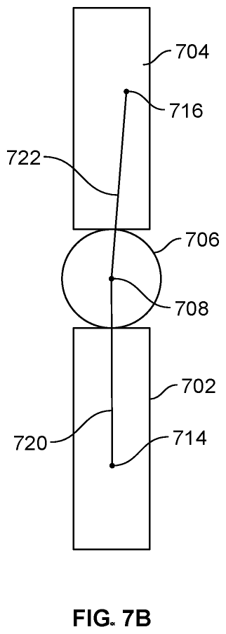

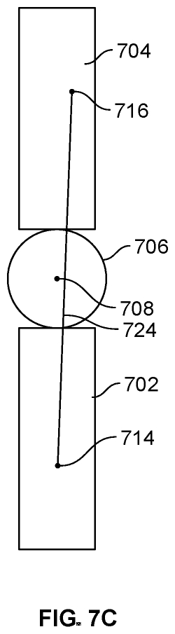

FIG. 7A, FIG. 7B, and FIG. 7C illustrate the change in cable path length as a joint rotates. In this example, a first member 702 is coupled to a second member 704 at a joint 706. A first cable 710 and a second cable 712 run from a first connector 714 on first member 702 to a second connector 716 on second member 704. First cable 710 is routed to bend through the axis of rotation 708 of joint 706 when transitioning across the joint from first member 702 to second member. Second cable 712 is routed near the radius of joint 706. As illustrated in FIG. 7B, as joint 706 rotates to move member 704 relative to member 702, the path length 720 from first connector 714 to the axis of rotation 708 and the path length 722 from the axis of rotation 708 to second connector 716 are the same as the respective path lengths in the arrangement of the members 702, 704 depicted in FIG. 7A. By routing cable 710 through the center of joint 706-—that is, routing cable 710 so the projected axis of rotation of joint 706 passes through cable 710—the cable path length does not change through the range of motion of joint 706. However, even the shortest cable path length 724 between first connector 714 and second connector 716 in the configuration of FIG. 7C is significantly longer than the path length of cable 712 in FIG. 7A. As such, cable 712, first connector 714, and second connector 716 can experience high stress as joint 706 rotates to move member 704 relative to member 702.

Some embodiments can provide excess cable between anchor points to reduce the ratio of cable path length change to cable length. Even more particularly, some embodiments have a ratio of cable path length change to cable length below a desired threshold, say .125. In some embodiments, this can be achieved by routing the cable to pass through the axis of rotation of an actuator—that is, the projected axis of rotation of the actuator will pass through the cable—as the cable transitions across the joint. In addition, or in the alternative, cables can be routed to maintain greater than a desired bend radius, say 20 mm or other desired bend radius. By maintaining a relatively large bend radius, the cable is less likely to experience undue local stresses that can propagate to apply stresses on the connectors and boards.

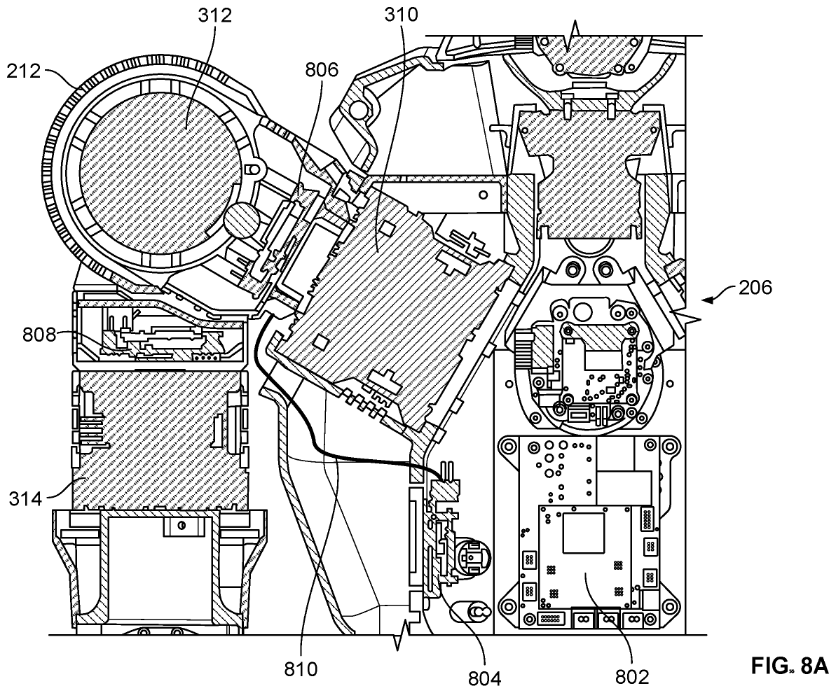

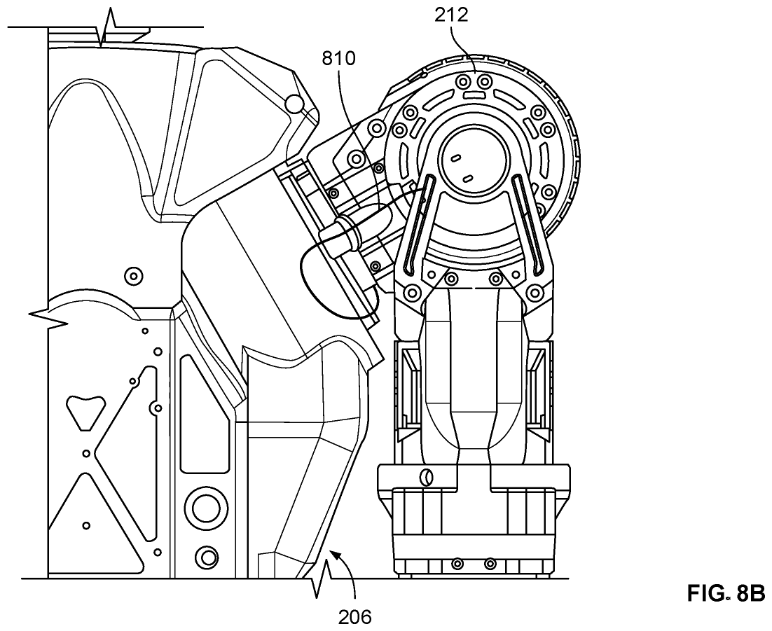

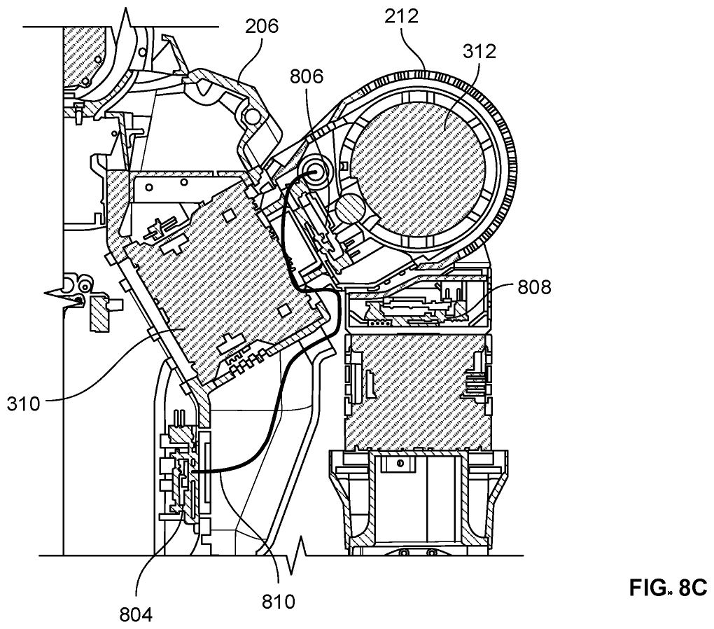

FIG. 8A, FIG. 8B, and FIG. 8C illustrate an example embodiment of routing wiring. In the embodiment illustrated, upper-body humanoid robot 200 includes power electronics hub 802 to distribute power and signals to the actuator drivers. In FIG. 8A, shoulder FE actuator driver 804, shoulder AA actuator driver 806, and arm IE rotation actuator driver 808 are illustrated. Wiring (not shown) runs internally from power electronics hub 802 to shoulder FE actuator driver 804. Shoulder AA actuator driver 806 is daisy chained to shoulder FE actuator driver 804 by cabling 810 to deliver power and signals to shoulder AA actuator driver 806. Here, cabling 810 exits the outer shell of upper torso 206. A small, external channel can be used to wrap cabling 810 partially around shoulder FE actuator 310, before cabling 810 transitions across to and re-enters the shoulder 212 to connect to shoulder AA actuator driver 806. The cable routing for cabling 810 minimizes external cabling. Furthermore, cabling 810 is routed such that cabling 810 is relatively long compared to the path length change through the range of motion of shoulder 212 relative to upper torso 206, thus minimizing strain on cabling 810 and the board connectors of shoulder FE actuator driver 804 and shoulder AA actuator driver 806.

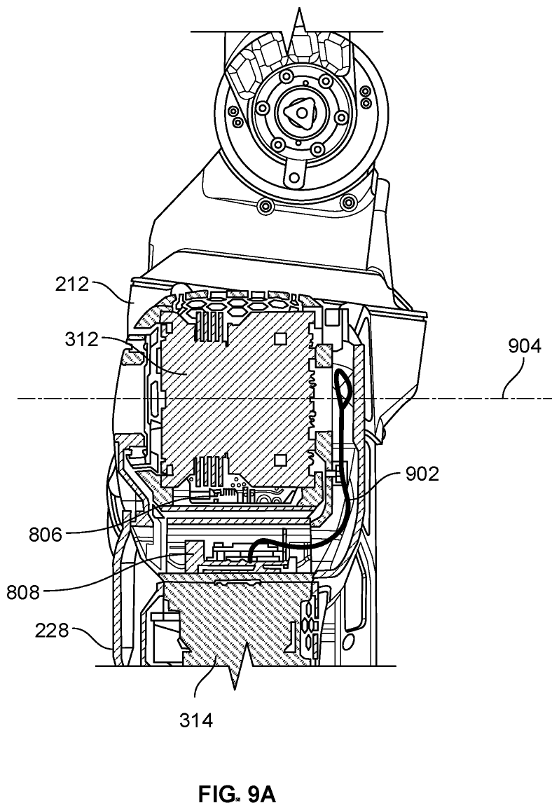

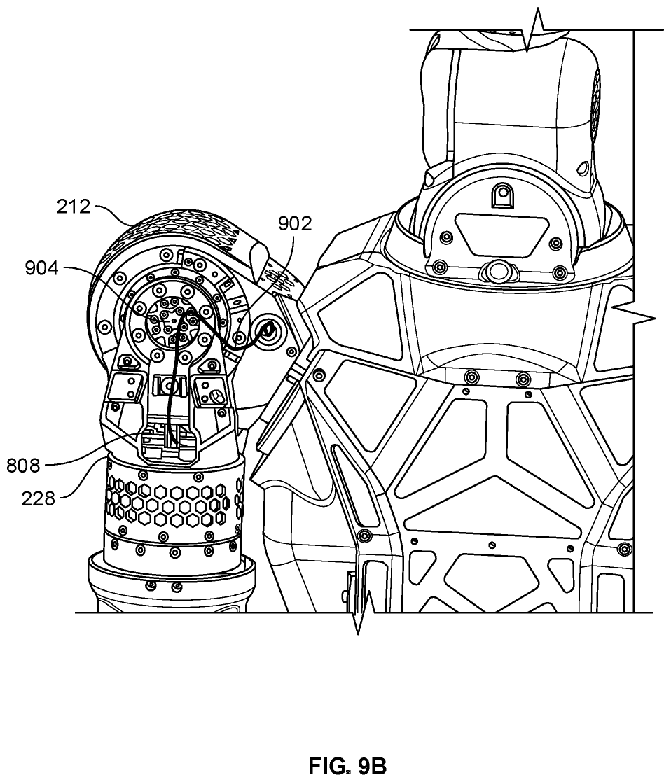

FIG. 9A and FIG. 9B illustrate an example embodiment of routing wiring from shoulder AA actuator driver 806 (obscured by shoulder AA actuator 312 in FIG. 9A) located in shoulder 212 to arm IE rotation actuator driver 808 located in upper bicep 228. Arm IE rotation actuator driver 808 is daisy chained to shoulder AA actuator driver 806 by cabling 902, which delivers power and signals to arm IE rotation actuator driver 808. Cabling 902 is routed to bend through the axis of rotation 904 of shoulder AA actuator 312. Consequently, cabling 902 will experience no path length change through the range of arm abduction-adduction motion.

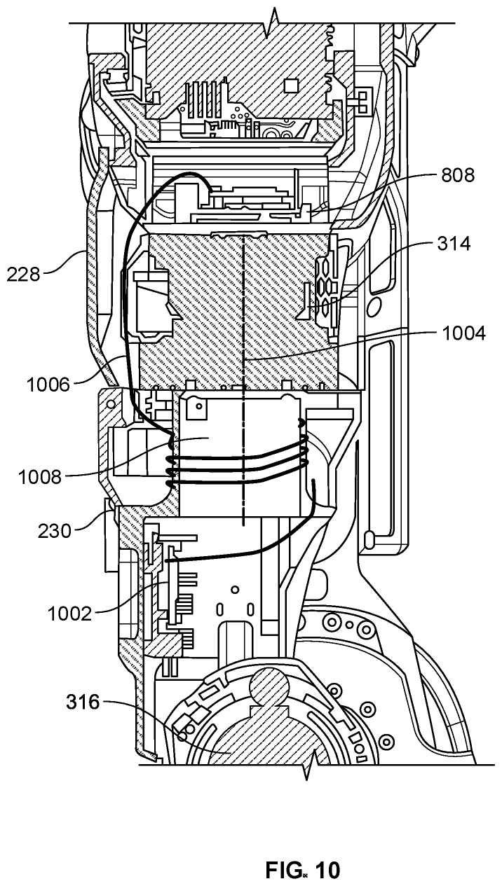

FIG. 10 illustrates an example embodiment of routing wiring from arm IE rotation actuator driver 808 located in upper bicep 228 to arm FE actuator driver 1002 located in lower bicep 230. Arm FE actuator driver 1002 is daisy chained to arm IE rotation actuator driver 808 by cabling 1006, which delivers power and signals to arm FE actuator driver 1002. In this embodiment, cabling 1006 is wrapped multiple times about a structure 1008 that is coaxial to the axis of rotation 1004 of arm IE rotation actuator 314. Structure 1008 (or other routing mechanism) maintains the minimum bend radius of cabling 1006 as it spirals to desired amount. By wrapping cabling 1006 about the axis of rotation 1004 of arm IE rotation actuator 314 with a minimum bend radius, cabling 1006 can be relatively long compared to the path length change for the IE range of motion of lower bicep 230 relative to upper bicep 228. Having a long wire length and a relatively small path length allows for minimal stress on cabling 1006 and the board connectors of arm IE rotation actuator driver 808 and arm FE actuator driver 1002.

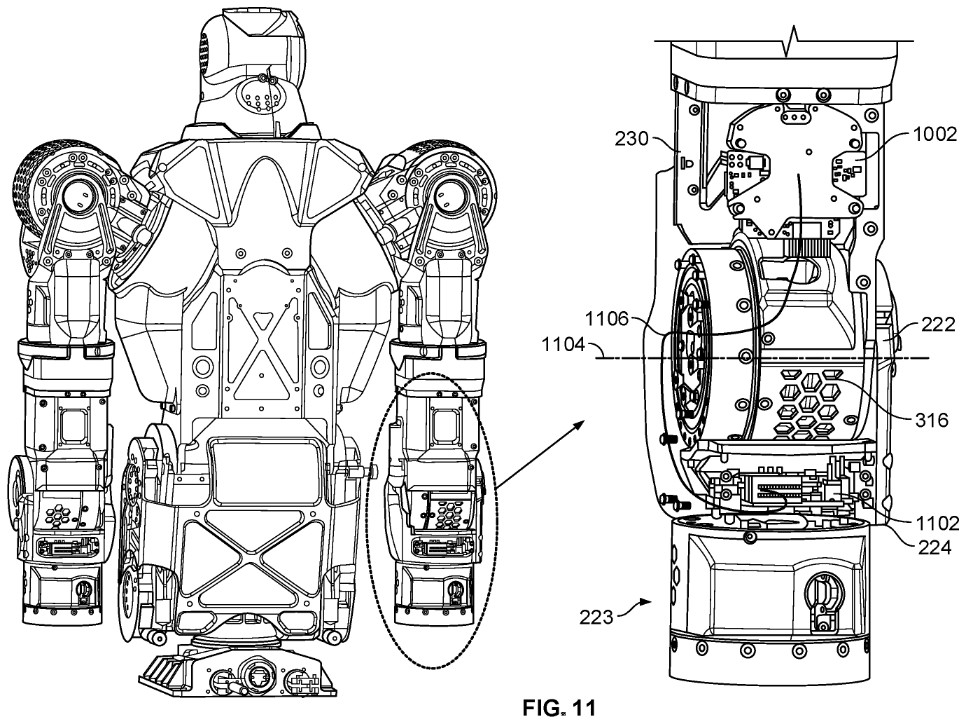

FIG. 11 illustrates an example embodiment or routing wiring from arm FE actuator driver 1002 located in upper bicep 228 to wrist yaw actuator driver 1102 located in forearm 224. In this example, wrist yaw actuator driver 1102 is daisy chained to arm FE actuator driver 1002 by cabling 1106, which crosses elbow 222 to deliver power and signals to wrist yaw actuator driver 1102. Cabling 1106 is routed to bend through the axis of rotation 1104 of arm FE actuator 316. Consequently, cabling 1106 will experience no path length change through the range of motion as arm FE actuator 316 flexes and extends lower arm 223 relative to lower bicep 230.

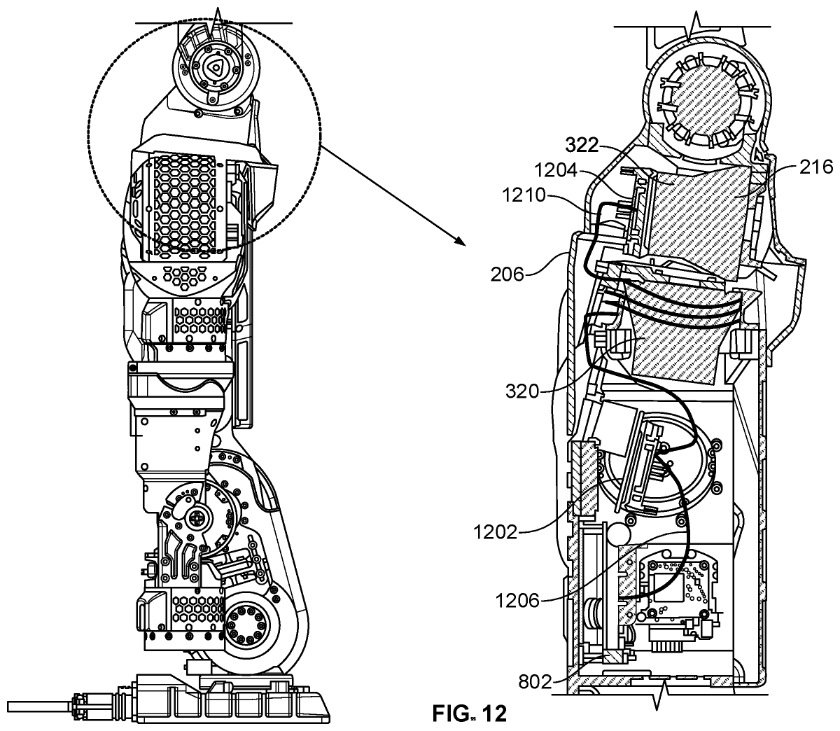

FIG. 12 illustrates an example embodiment of routing wiring to neck yaw actuator driver 1202 and neck roll actuator driver 1204. Here, cabling 1206 connects between power electronics hub 802 and neck yaw actuator driver 1202. The routing can be relatively trivial in this embodiment and power electronics hub 802 and neck yaw actuator driver 1202 are both in upper torso 206 and do not move relative to each other.

Neck roll actuator driver 1204 in lower neck 216 is daisy chained to neck yaw actuator driver 1202 by cabling 1210, which delivers power and signals to neck roll actuator driver 1204. The wire path for cabling 1210 is defined such that cabling 1210 wraps around a circumference coaxial with the axis of rotation of neck yaw actuator 320 multiple times (e.g., with a desired minimum bend radius) and then transitions to lower neck 216. By wrapping cabling 1210 about neck yaw actuator 320 with a minimum bend radius, the length of cabling 1210 can be maximized compared to the path length change for the yaw range of motion of lower neck 216 relative to upper torso 206. Having a long wire length and a relatively small path length allows for minimal stress on cabling 1210 and the board connectors of neck yaw actuator driver 1202 and neck roll actuator driver 1204.

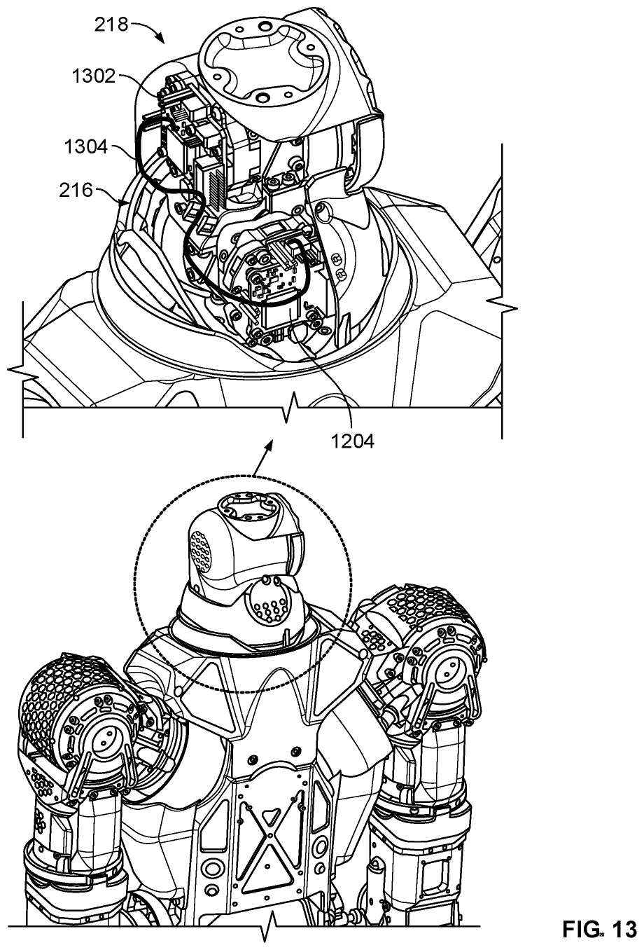

FIG. 13 illustrates an example embodiment of routing wiring from neck roll actuator driver 1204 located in lower neck 216 to neck pitch actuator driver 1302 located in upper neck 218. Neck pitch actuator driver 1302 is daisy chained to neck roll actuator driver 1204 by cabling 1304, which delivers power and signals to neck pitch actuator driver 1302. Cabling 1304 is routed to bend through the axis of rotation of neck roll actuator 322 when transitioning across lower neck 216 from neck roll actuator driver 1204 to upper neck 218. Consequently, cabling 1304 will experience no path length change through the range of roll motion upper neck 218 relative to lower neck 216.

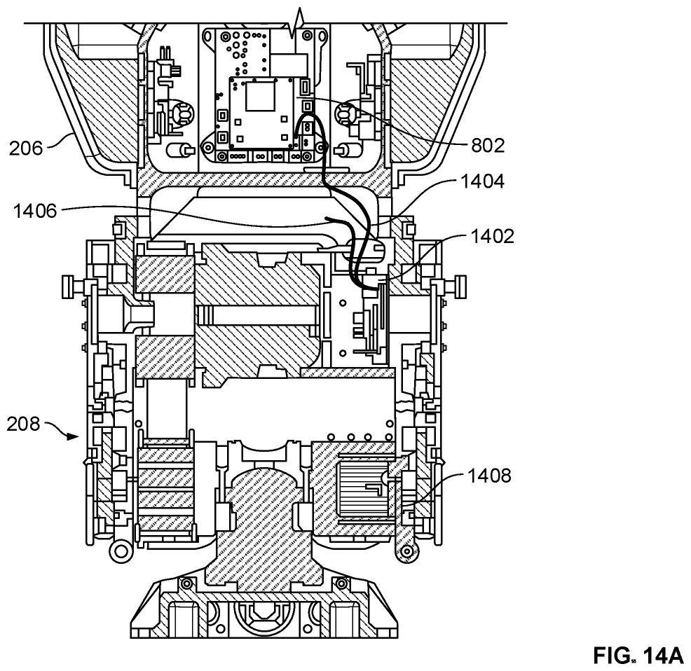

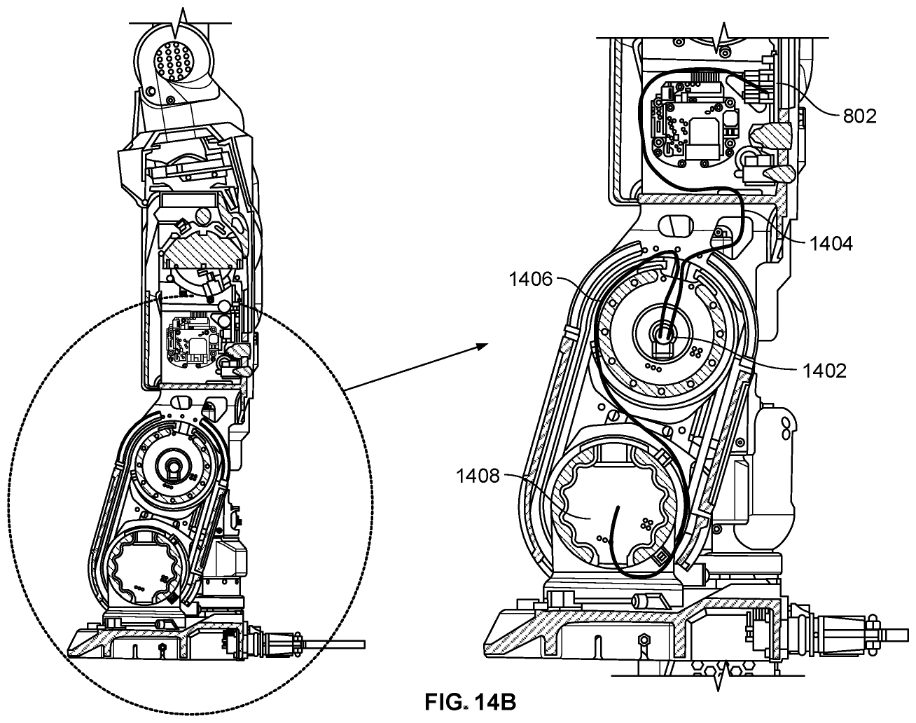

FIG. 14A and FIG. 14B illustrate an example embodiment of routing cabling 1404 from power electronics hub 802 to torso pitch actuator driver 1402. Since there is little to no relative motion between power electronics hub 802 and torso pitch actuator driver 1402, there is also minimal or no cable path length change. As such, the primary routing concern is bending cabling 1404 such that it has a minimum desired bend radius. It can be noted that cabling 1404 is illustrated as connecting to power electronics hub 802 at a slightly higher location in FIG. 14B than in FIG. 14A to create a larger bend. The connectors for various cabling on power electronics hub 802 and the various actuator drivers described herein can be placed in various locations based on the desired cable routing characteristics. Cabling 1406 runs from torso pitch actuator driver 1402 to torso yaw actuator driver 1408 in an S-like path through the torso rolling joint. Routing cabling 1406 in an s-like path increases the cable length relative to cable path length, reducing—for example, minimizing—the ratio of path length change to cable length.

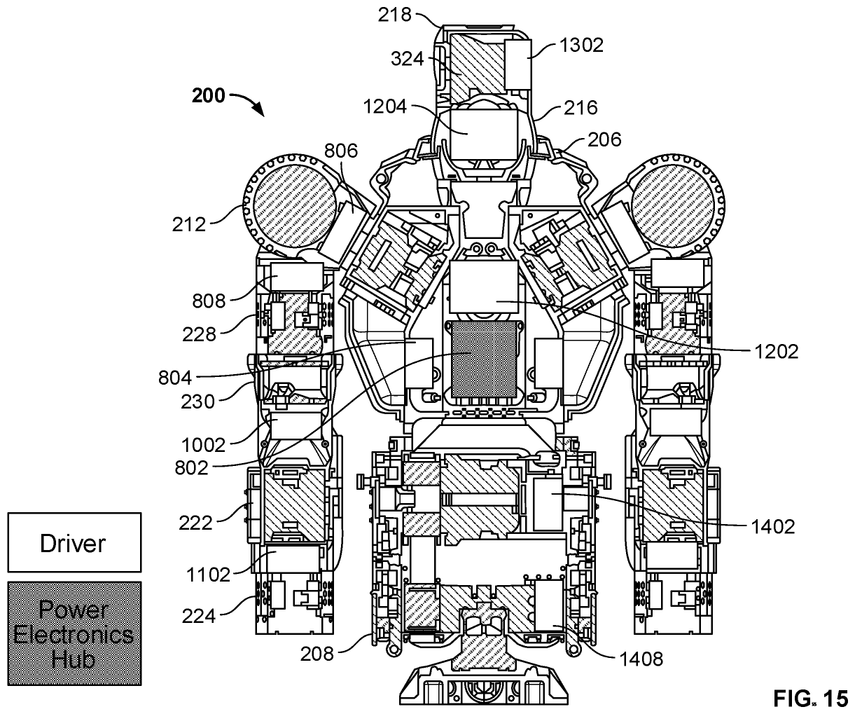

The wire bundle between a driver and the actuator it drives is relatively large and sensitive. It can therefore be desirable to distribute the actuator drivers so that there is no relative motion between an actuator driver and the overall actuator that it drives. FIG. 15 illustrates an example embodiment of distributing electronics such that the actuator driver for each actuator is contained in the same portion of the upper-body humanoid robot 200 as the actuator which it drives. Consequently, the actuator driver and actuator do not move relative to each other as that portion of upper-body humanoid robot 200 moves relative to other portions of the upper-body humanoid robot 200. As such, wiring from an actuator driver to the actuator can be trivial in most cases.

For example, as depicted in FIG. 8A, shoulder FE actuator driver 804 and shoulder FE actuator 310 are contained in upper torso 206 and shoulder AA actuator driver 806 and shoulder AA actuator 312 are contained in shoulder 212. In addition, as can be seen in FIGS. 10 and 11, arm IE rotation actuator driver 808 and arm IE rotation actuator 314 are contained in upper bicep 228, arm FE actuator driver 1002 is contained in upper bicep 228 which moves with elbow 222 that contains arm FE actuator 316, wrist yaw actuator driver 1102 and wrist yaw actuator 318 are contained in lower arm 223. As depicted in FIGS. 12, 13 and 15, neck yaw actuator driver 1202 and neck yaw actuator 320 are contained in upper torso 206, neck roll actuator driver 1204 and neck roll actuator 322 are contained in lower neck 216, and neck pitch actuator driver 1302 and neck pitch actuator 324 are contained in upper neck 218. Similarly, torso pitch actuator driver 1402 and torso pitch actuator 304 move together and torso yaw actuator driver 1408 and torso yaw actuator 302 both move together with lower torso 208.

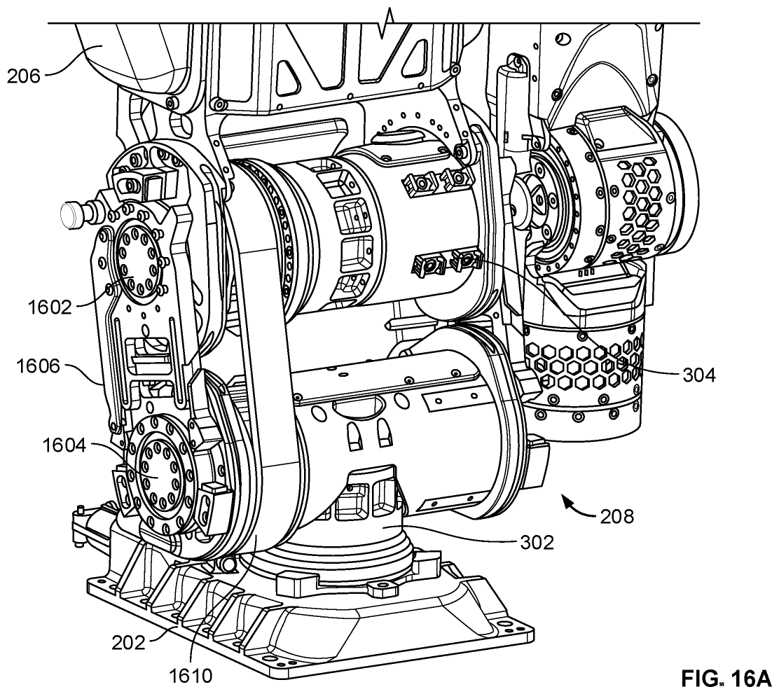

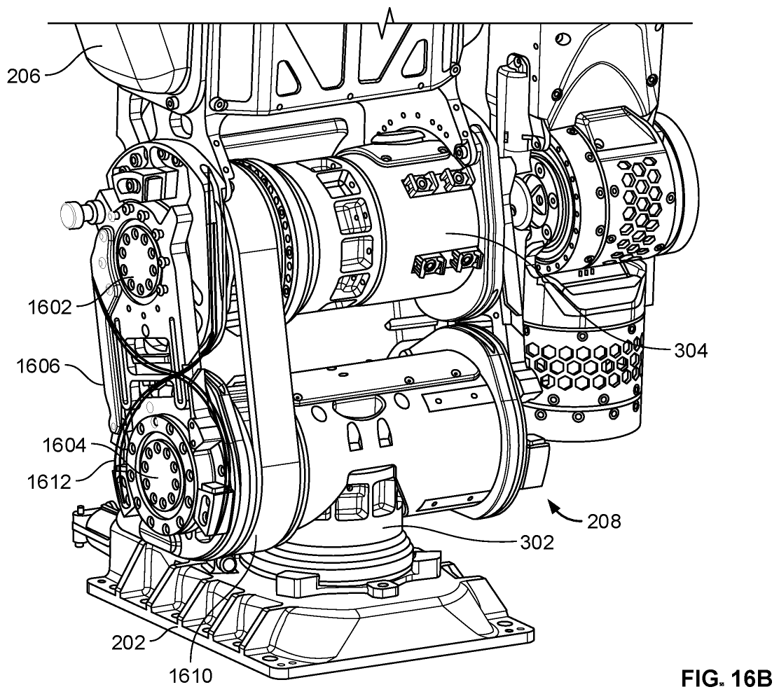

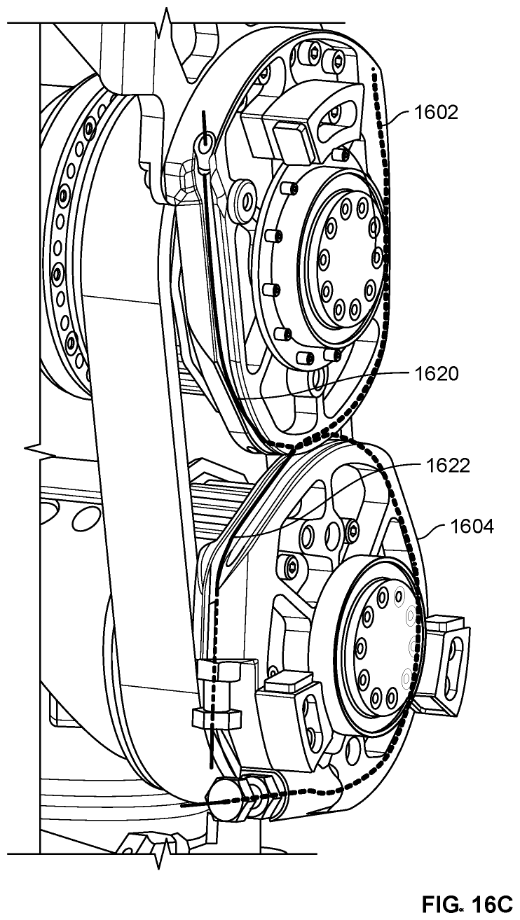

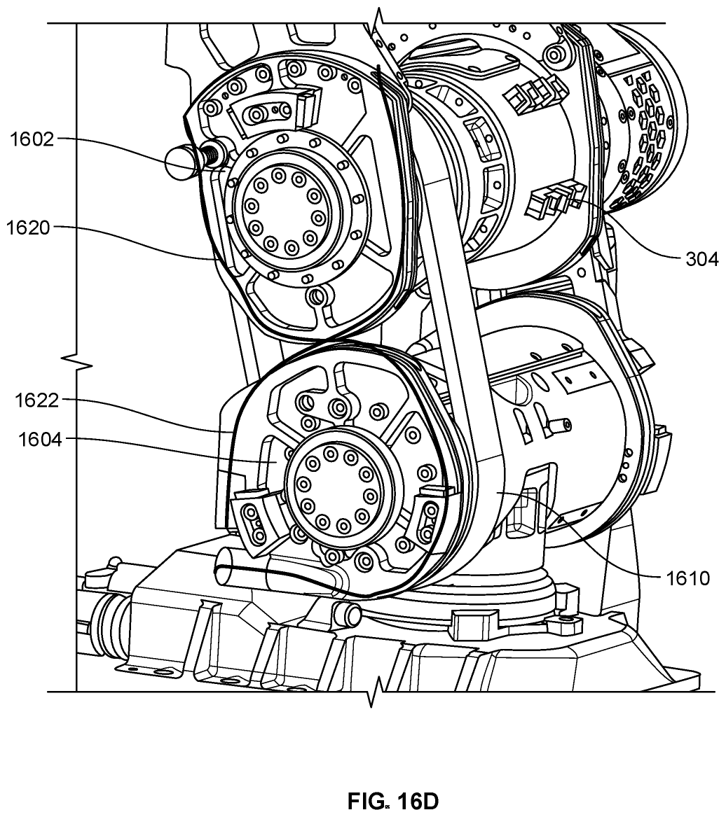

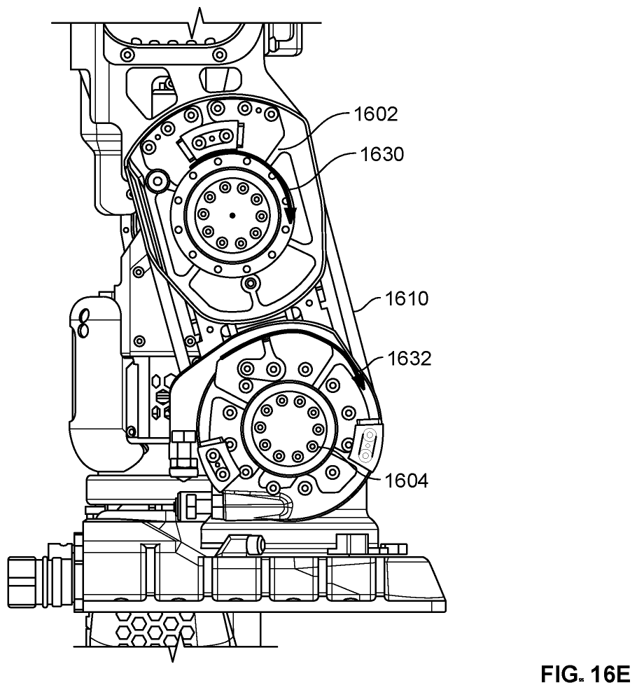

FIG. 16A, FIG. 16B, FIG. 16C, FIG. 16D, and FIG. 16E illustrate an example embodiment of a torso rolling joint. Torso rolling joint comprising an upper joint 1602 and a lower joint 1604. As will be appreciated, a structure acts as a radial constraint 1606 to maintain upper joint 1602 and lower joint 1604 a set distance apart. Torso pitch actuator 304 drives power transmission belt 1610, which causes upper joint 1602 to rotate and translate relative to lower joint 1604. A rotational constraint 1612 rotationally constrains upper joint 1602 to lower joint 1604. Together, radial constraint 1606 and rotational constraint 1612 couple rotation and translation of upper joint 1602 to lower joint 1604-producing a single degree of freedom motion. In an example embodiment, rotational constraint 1612 can comprise a first rotational constraint cable 1620 and second rotational constraint cable 1622 that are connected to upper joint 1602 and lower joint 1604 and are routed as illustrated in FIG. 16C. As shown, each rotational constraint cable 1620, 1622 is wrapped around opposite sides of the circumference of each of upper joint 1602 and lower joint 1604. The rotational constraint cables 1620, 1622 are terminated at both joints 1602, 1604. In an example embodiment, one end of each rotational constraint cable 1620, 1622 is terminated in an adjustable manner to allow the cables 1620, 1622 to be tightened. As torso pitch actuator 304 spins, it drives power transmission belt 1610 causing upper joint 1602 to translate about the arc 1632 and rotate about the upper joint center, as indicated by arc 1630, causing upper torso 206 to pitch relative to lower torso 208.

Appendix A, which is incorporated as part of this written description, further describes an example embodiment of an upper-body humanoid robot.

It will be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

In the description herein, numerous specific details are provided, such as examples of components and/or methods, to provide a thorough understanding of embodiments of the disclosure. One skilled in the relevant art will recognize, however, that an embodiment can be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the disclosure. While the disclosure may illustrate a particular embodiment, this is not and does not limit the disclosure to any particular embodiment and a person of ordinary skill in the art will recognize that additional embodiments are readily understandable and are a part of this disclosure.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Reference throughout this specification to “an example embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in an example embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the disclosure.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such non-limiting examples and illustrations includes, but is not limited to: “for example,” “for instance,” “e.g.,” and “in an example embodiment.”

Thus, while specific embodiments have been described, these embodiments are merely illustrative, and not restrictive of the disclosure. Rather, the description is intended to describe illustrative embodiments, features and functions in order to provide a person of ordinary skill in the art context to understand the disclosure without limiting the disclosure to any particularly described embodiment, feature or function, including any such embodiment feature or function described. While specific embodiments of, and examples for, the disclosure are described herein for illustrative purposes only, various equivalent modifications are possible within the spirit and scope of the disclosure, as those skilled in the relevant art will recognize and appreciate.

As indicated, these modifications may be made to the disclosure in light of the foregoing description of illustrated embodiments of the disclosure and are to be included within the spirit and scope of the disclosure. Thus, while particular embodiments have been described herein, a latitude of modification, various changes and substitutions are intended in the foregoing disclosures, and it will be appreciated that in some instances some features of embodiments of the disclosure will be employed without a corresponding use of other features without departing from the scope and spirit of the disclosure as set forth. Therefore, many modifications may be made to adapt a particular situation or material to the essential scope and spirit of the disclosure.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

1. A humanoid robot, comprising:
a base;
a robotic torso coupled to the base;
at least one robotic arm;
at least one robotic shoulder coupling the at least one robotic arm to the robotic torso;
a robotic neck coupled to the robotic torso; and
a plurality of actuators configured to move at least a portion of at least one of the robotic torso, the at least one robotic arm, the at least one robotic shoulder, and the robotic neck, each of the robotic torso, the at least one robotic arm, the at least one robotic shoulder, and the robotic neck defined by one or more proportions that deviates less than 25% from respective proportions of a human envelope.

2. The humanoid robot of claim 1, wherein a height of the robotic torso ranges between 75% of a height of an average human torso and 125% of the height of the average human torso.

3. The humanoid robot of claim 1, wherein a width of the robotic shoulder ranges between 75% of a width of an average human shoulder and 125% of the width of the average human shoulder.

4. The humanoid robot of claim 1, wherein the at least one robotic arm comprises:
a robotic bicep;
a robotic forearm;
a robotic elbow coupling the robotic bicep and the robotic forearm; and
a robotic wrist.

5. The humanoid robot of claim 4, wherein a length of the robotic bicep ranges between 75% of a length of an average human bicep and 125% of the length of the average human bicep.

6. The humanoid robot of claim 4, wherein a length of the robotic forearm ranges between 75% of a length of an average human forearm and 125% of the length of the average human forearm.

7. The humanoid robot of claim 4, wherein the plurality of actuators comprises a shoulder abduction-adduction (AA) actuator coupled to the robotic shoulder and the robotic bicep, the shoulder AA actuator configured to control abduction and adduction of the robotic arm.

8. The humanoid robot of claim 7, further comprising a shoulder FE output structure configured to couple the shoulder AA actuator with a shoulder FE actuator configured to control flexion and extension of the robotic arm, the shoulder FE output structure configured to act as a mechanical ground for the shoulder AA actuator and configured to cause abduction and adduction of the robotic arm.

9. The humanoid robot of claim 8, wherein the shoulder FE output structure comprises:
a first arm coupled to a first side of the shoulder AA actuator; and
a second arm coupled to a second side of the shoulder AA actuator.

10. The humanoid robot of claim 8, further comprising a shoulder AA output structure, the shoulder AA output structure comprising:
a first arm coupled to the shoulder AA actuator; and
a second arm coupled to the shoulder FE output structure.

11. The humanoid robot of claim 10, wherein the shoulder AA output structure is coupled to the shoulder FE output structure by a bearing.

12. The humanoid robot of claim 8, further comprising:
a shoulder AA actuator driver configured to move the shoulder AA actuator; and
cabling configured to electronically couple the shoulder AA actuator driver to an electronic controller, the cabling extending between the shoulder AA actuator driver and a shoulder FE actuator driver.

13. The humanoid robot of claim 4, wherein the plurality of actuators comprises an arm internal/external (IE) rotation actuator coupled to the robotic bicep, the arm IE rotation actuator configured to control internal rotation and external rotation of the robotic arm.

14. The humanoid robot of claim 13, further comprising:
an arm IE rotation actuator driver configured to move the arm IE rotation actuator; and
cabling configured to electronically couple the arm IE rotation actuator driver to an electronic controller, the cabling extending between the arm IE rotation actuator driver and a shoulder AA actuator driver.

15. The humanoid robot of claim 14, wherein the cabling is routed to bend through an axis of rotation of a shoulder AA actuator corresponding to the shoulder AA actuator driver.

16. The humanoid robot of claim 4, wherein the plurality of actuators comprises an arm flexion-extension (FE) actuator coupled to the robotic elbow, the arm FE actuator configured to control flexion and extension of the robotic forearm relative to the robotic bicep.

17. The humanoid robot of claim 16, further comprising an IE rotation output structure configured to couple the arm FE actuator with an arm IE rotation actuator configured to internal rotation and external rotation of the robotic arm, the IE rotation output structure configured to act as a mechanical ground for the arm FE actuator and configured to cause rotation of a lower portion of the robotic bicep relative to an upper portion of the robotic bicep.

18. The humanoid robot of claim 17, wherein the IE rotation output structure comprises:
a first arm coupled to a first side of the arm FE actuator; and
a second arm coupled to a second side of the arm FE actuator.

19. The humanoid robot of claim 16, further comprising:
an arm FE actuator driver configured to move the arm FE actuator; and
cabling configured to electronically couple the arm FE actuator driver to an electronic controller, the cabling extending between the arm FE actuator driver and an arm IE rotation actuator driver.

20. The humanoid robot of claim 19, wherein the cabling is routed to wrap around a structure coaxially with an axis of rotation of an arm IE rotation actuator corresponding to the arm IE rotation actuator driver.

21. The humanoid robot of claim 4, wherein the plurality of actuators comprises a wrist yaw actuator coupled to the robotic wrist and configured to rotate a tool connected to the robotic arm.

22. The humanoid robot of claim 21, further comprising an elbow output structure configured to couple the wrist yaw actuator with an arm FE actuator configured to control flexion and extension of the robotic forearm relative to the robotic bicep, the elbow output structure configured to act as a mechanical ground for the wrist yaw actuator and configured to cause flexion and extension of the robotic forearm relative to the robotic bicep.

23. The humanoid robot of claim 22, wherein the elbow output structure comprises:
a first arm coupled to the arm FE actuator; and
a second arm coupled to an IE rotation output structure.

24. The humanoid robot of claim 23, wherein the second arm is coupled to the IE rotation output structure by a bearing.

25. The humanoid robot of claim 21, further comprising:
a wrist yaw actuator driver configured to move the wrist yaw actuator; and
cabling configured to electronically couple the wrist yaw actuator driver to an electronic controller, the cabling extending between the wrist yaw actuator driver and an arm FE actuator driver.

26. The humanoid robot of claim 25, wherein the cabling is routed to bend through an axis of rotation of an arm FE actuator corresponding to the arm FE actuator driver.

27. The humanoid robot of claim 1, wherein the plurality of actuators comprises a torso yaw actuator coupled to the robotic torso and the base and configured to rotate the robotic torso relative to the base.

28. The humanoid robot of claim 27, further comprising:
a torso yaw actuator driver configured to move the torso yaw actuator; and
cabling configured to electronically couple the torso yaw actuator driver to an electronic controller, the cabling extending between the torso yaw actuator driver and torso pitch actuator driver.

29. The humanoid robot of claim 28, wherein the cabling is routed in an S-shaped path between the torso yaw actuator driver and the torso pitch actuator driver.

30. The humanoid robot of claim 1, wherein:
the robotic torso comprises an upper torso and a lower torso; and
the plurality of actuators comprises a torso pitch actuator coupled to the upper torso and the lower torso, the torso pitch actuator configured to control angular movement of the upper torso forwards and backwards relative to the lower torso.

31. The humanoid robot of claim 30, further comprising a torso rolling joint, the torso rolling joint comprising:
an upper joint;
a lower joint;
a radial constraint configured to maintain a distance between the upper joint and the lower joint; and
a transmission belt driven by the torso pitch actuator to cause the upper joint to translate relative to the lower joint.

32. The humanoid robot of claim 31, wherein the torso rolling joint further comprises at least one rotational constraint cable coupled to the upper joint and the lower joint and configured to constrain rotational movement of the upper joint and the lower joint.

33. The humanoid robot of claim 1, wherein the plurality of actuators comprises a shoulder flexion-extension (FE) actuator coupled to the robotic torso and the robotic shoulder, the shoulder FE actuator configured to control flexion and extension of the robotic arm.

34. The humanoid robot of claim 1, wherein the plurality of actuators comprises a neck yaw actuator coupled to the robotic torso and the robotic neck, the neck yaw actuator configured to rotate the robotic neck relative to the robotic torso.

35. The humanoid robot of claim 1, wherein:
the robotic neck comprises an upper neck portion and a lower neck portion; and
the plurality of actuators comprises a neck roll actuator coupled to the lower neck portion and configured to control movement of the upper neck portion relative to the lower neck portion.

36. The humanoid robot of claim 35, further comprising:
a neck roll actuator driver configured to move the neck roll actuator; and
cabling configured to electronically couple the neck roll actuator driver to an electronic controller, the cabling extending between the neck roll actuator driver and a neck yaw actuator driver.

37. The humanoid robot of claim 36, wherein the cabling is routed and configured to bend through an axis of rotation of a neck yaw actuator corresponding to the neck yaw actuator driver.

38. The humanoid robot of claim 1, wherein the plurality of actuators comprises a neck pitch actuator coupled to the robotic neck and configured to control angular movement of a head coupled to the robotic neck.

39. The humanoid robot of claim 38, further comprising:
a neck pitch actuator driver configured to move the neck pitch actuator; and
cabling configured to electronically couple the neck pitch actuator driver to an electronic controller, the cabling extending between the neck pitch actuator driver and a neck roll actuator driver.

40. The humanoid robot of claim 39, wherein the cabling is routed and configured to bend through an axis of rotation of a neck roll actuator corresponding to the neck roll actuator driver.

41. The humanoid robot of claim 1, further comprising:
a plurality of actuator drivers corresponding to the plurality of actuators and configured to move the respective a plurality of actuators; and
an electronic controller communicably coupled to each of the plurality of actuator drivers.

42. The humanoid robot of claim 41, wherein each of the plurality of actuator drivers are positioned relative to the respective actuator of the plurality of actuators to prevent movement of the respective actuator driver relative to the respective actuator.

43. The humanoid robot of claim 41, further comprising cabling communicably coupling each of the plurality of actuator drivers to the electronic controller.

44. The humanoid robot of claim 43, wherein a ratio between a length of a cable path between two of the plurality of actuator drivers to a total length of the cabling is less than or equal to 0.125.

45. The humanoid robot of claim 43, wherein the cabling is configured to maintain a bend radius greater than or equal to 20 millimeters.
